(19) United States
(12) Patent Application Publication
(10) Pub. No.: US 2025/0304757 A1
(43) Pub. Date: Oct. 2, 2025

(54) STRAW-BASED MODIFIED BIOFILM, AND PREPARATION METHOD AND USE THEREOF

(71) Applicant: CHINA AGRICULTURAL UNIVERSITY, Beijing (CN)

(72) Inventors: Guoxue Li, Beijing (CN); Jing Yuan, Beijing (CN); Guoliang Liu, Beijing (CN); Wenhai Luo, Beijing (CN)

(21) Appl. No.: 18/761,856

(22) Filed: Jul. 2, 2024

(30) Foreign Application Priority Data
Mar. 28, 2024 (CN) 202410370499.9

(51) Int. Cl. C08J 5/18; C05F 17/80; C08J 3/24; C08J 5/24

(52) U.S. Cl. CPC C08J 5/18; C05F 17/80; C08J 3/24; C08J 5/245; C08J 2399/00; C08J 2471/02

(57) ABSTRACT

Provided are a straw-based modified biofilm, and a preparation method and use thereof. In the method, crop straw is liquefied into a mixed organic solvent-biological polyol, and then the biological polyol is used as a cross-linking agent to cross-link and couple a native crop straw. A curing agent is added during the cross-linking and coupling, thereby obtaining the straw-based modified biofilm.

### CROSS REFERENCE TO RELATED APPLICATION

This patent application claims the benefit and priority of Chinese Patent Application No. 2024103704999 filed with the China National Intellectual Property Administration on Mar. 28, 2024, the disclosure of which is incorporated by reference herein in its entirety as part of the present application.

### TECHNICAL FIELD

The present disclosure relates to the technical field of biofilms, and in particular relates to a straw-based modified biofilm, and a preparation method and use thereof.

### BACKGROUND

With the advancement of science and technology and the development of agricultural modernization, the output of crop straw is increasing annually. Agricultural straw generally refers to the remaining part of wheat, rice, corn, potatoes, oilseeds, cotton, sugar cane, and other crops after harvesting their seeds. As a typical high-carbon source lignocellulosic waste, the straw has always been a matter of great concern for its resource treatment. At the same time, the structure of livestock and poultry industry in China is rapidly changing from traditional free-range farming to large-scale and intensive production, causing the production of livestock and poultry manure to grow at an extremely fast rate. Composting is an effective means of recycling the livestock and poultry manure. However, the composting generally produces a large amount of odor (such as NH₃ and H₂S), which not only reduces the nutrient content of compost products, but also harms the health of surrounding people and produces secondary pollution.

Crop straw has high carbon content, large particle size, and strong water absorption, and can regulate the moisture content of the pile, increase porosity, and reduce odor emissions. Accordingly, the crop straw is generally used as an auxiliary material to be added into the pile. The crop straw can also be directly covered on top of the pile with simple operations. However, the emission reduction effect of native crop straw is always limited and unstable due to loose texture, poor cohesion, high air permeability, and easy mixing into the pile during turning.

At present in the industry, there is an intelligent molecular membrane resistance control technology that uses a special functional membrane as a covering for the aerobic fermentation treatment of organic waste. The functional membrane shows selective permeability, and small molecular gases such as water vapor and carbon dioxide can pass through the membrane, while large molecular gases such as odor are blocked, thus exhibiting a desirable interception effect on the odor generated during the composting. However, molecular membranes are expensive, and their applications can significantly increase the cost of composting, making them difficult to implement in some composting projects.

### SUMMARY

In view of this, the present disclosure provides a straw-based modified biofilm, and a preparation method and use thereof. Crop straw is liquefied into a mixed organic solvent-biological polyol, and then the biological polyol is used as a cross-linking agent to cross-link and couple a native crop straw, and a curing agent is added during the cross-linking and coupling to enhance a cross-linking effect, thereby obtaining the straw-based modified biofilm with a compact structure, a high mechanical strength, and excellent adsorption properties. Furthermore, the straw-based modified biofilm is applied in the odor control of aerobic composting, and can achieve a significant reduction effect in odor emission.

A first object of the present disclosure is to provide a method for preparing a straw-based modified biofilm, including the following steps:
(1) mixing straw, a polyol, and a curing agent evenly to obtain a mixture for later use; and
(2) extending the mixture obtained in step (1) into a film, and subjecting the film to curing molding by reacting at a temperature of 70° C. to 80° C. for 15 min to 20 min to obtain the straw-based modified biofilm.

In some embodiments, the straw is any crop straw known in the art, including but not limited to one or more selected from the group consisting of corn straw, wheat straw, rice straw, potato straw, rape straw, cotton straw, and sugarcane straw, preferably the corn straw.

In some embodiments, a mass ratio of the straw, the polyol, and the curing agent in step (1) is in a range of (1-2):5:5.

In some embodiments, the polyol in step (1) is a biological polyol.

In some embodiments, the biological polyol is prepared by a process including the following steps:
mixing the straw, a liquefier, and a catalyst, and subjecting a resulting mixture to a reaction to obtain the biological polyol.

In some embodiments, the liquefier is a mixture of polyethylene glycol-400 (PEG 400) and ethylene glycol (EG), and a mass ratio of the PEG 400 to the EG in the mixture is in a range of 3:1 to 7:2;
the catalyst is concentrated sulfuric acid with a mass concentration of 98%, and the concentrated sulfuric acid is added in an amount of 2.8% to 3.2% of a mass of the liquefier;
the straw has a size of 2 meshes to 8 meshes and a moisture content of 5% to 10%; and
a mass ratio of the straw to the liquefier is in a range of 1:(7-8).

In some embodiments, the reaction is conducted at a temperature of 145° C. to 155° C. for 30 min to 40 min.

In some embodiments, the curing agent in step (1) comprises any one selected from the group consisting of polymethylene polyphenyl polyisocyanate (PAPI), toluene diisocyanate (TDI), and methylenediphenyl diisocyanate (MDI), preferably the PAPI.

In some embodiments, the polyol, the PAPI, and the straw, which are raw materials for preparing the modified biofilm, have a total consumption of (2000±50) g/m³.

A second object of the present disclosure is to provide a straw-based modified biofilm prepared by the method as mentioned above.

In some embodiments, the straw-based modified biofilm is black, and has a thickness of 0.8 cm to 1.2 cm, a tensile strength of 65 N to 75 N, a bulk density of 19.2 kg·m⁻³ to 20.2 kg·m⁻³, and a saturated water absorption rate of 0.98 g·g⁻¹ to 1.08 g·g⁻¹.

In the present disclosure, the biological polyol is used as a cross-linking agent to cross-link and couple the straw. In order to enhance a cross-linking effect and ensure that the mixed raw materials can be cured and molded, a polymer resin PAPI with the same mass as the polyol is further introduced as a curing agent. The above three raw materials are mixed and extended to form a film, and then polymerized and cured to form the straw-based modified biofilm.

In the present disclosure, the polyol and the curing agent undergo polymerization to generate a degradable polyurethane foam, which is a main component of the straw-based modified biofilm, causing an apparent state of the film to appear black. Further, the straw-based modified biofilm is endowed with the characteristics of polyurethane foam, making its surface rich in oxygen-containing functional groups, with complex pore structure, high tensile strength, and bendability, and the biofilm is light and easy to transport. In addition, the addition of native straw plays a supporting role in the polyurethane foam and improves the mechanical strength of the biofilm. Meanwhile, the straw also provides more adsorption sites on a surface of the biofilm.

A third object of the present disclosure is to provide use of the straw-based modified biofilm in in-situ control of odor emission during aerobic composting.

In some embodiments, the use specifically includes: conducting the composting in a closed space, and using the straw-based modified biofilm as an adsorption and interception material to cover a surface of a composting material. In some embodiments, during the adsorption, the composting material has a moisture content adjusted to 60% to 70% and a carbon-to-nitrogen ratio of 15 to 25. In some embodiments, during the in-situ control of odor emission, oxygen needs to be supplemented, with a ventilation rate of 0.18-0.24 L·kg⁻¹ DM·min⁻¹, and a pile is turned over every 7 days.

In some embodiments, indicators of an odor emission reduction effect are the emissions of ammonia (NH₃) and hydrogen sulfide (H₂S).

Compared with the prior art, some embodiments of the present disclosure have the following beneficial effects:
1. The production of the straw-based modified biofilm realizes the resource utilization of crop straw, and its application in aerobic composting can achieve a better odor emission reduction effect and reduce secondary pollution of the environment by composting gas.
2. Compared with molecular membranes, the straw-based modified biofilm can significantly reduce composting costs while ensuring a better compost odor emission reduction effect. Not only that, the straw-based modified biofilm is also easy to move and saves energy investment in mechanical equipment such as film rolling machines. The biofilm can also be turned into the pile as a part of the pile in the later stages of composting, and its degradable characteristics can promote the composting of the pile.

### BRIEF DESCRIPTION OF THE DRAWINGS

FIG. 1A-1B show physical pictures of the straw-based modified biofilm in Example 1 of the present disclosure;

FIG. 2A-2B show experimental example diagrams of aerobic composting gas emission reduction of the straw-based modified biofilm in Example 1 of the present disclosure;

FIG. 3A-3B show electron microscope scanning images of the surface of the straw-based modified biofilm in Example 1 of the present disclosure;

FIG. 4 shows Fourier transform infrared analysis spectra of the surfaces of the straw-based modified biofilm in Example 1 of the present disclosure and native corn straw; and

FIG. 5A-5D show the emissions of ammonia (NH₃) and hydrogen sulfide (H₂S) during the aerobic composting gas emission reduction experiment of the straw-based modified biofilm in Example 1 of the present disclosure.

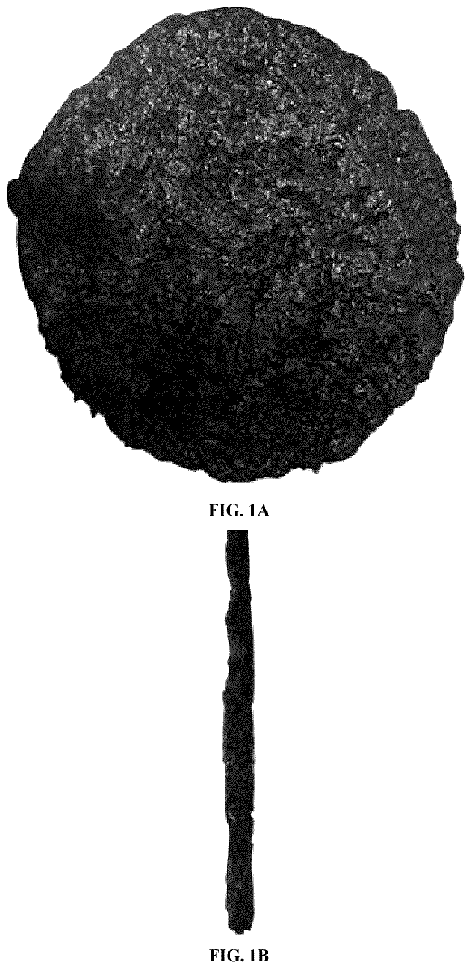

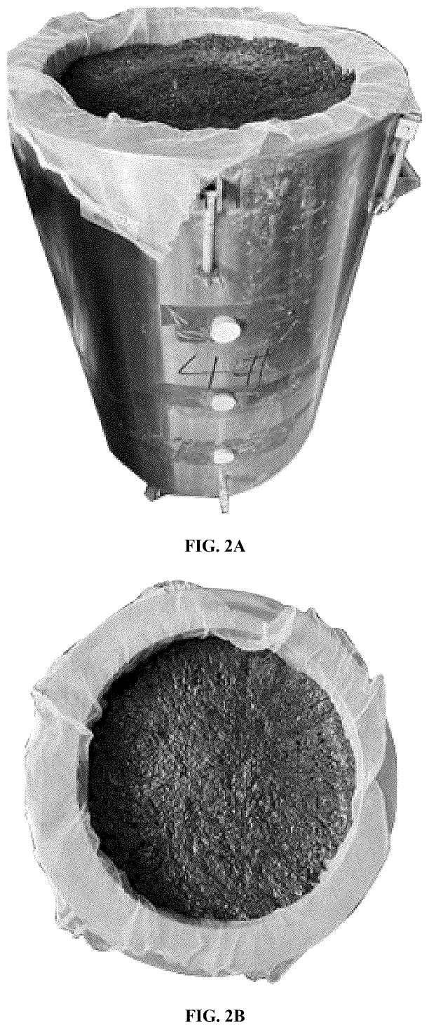

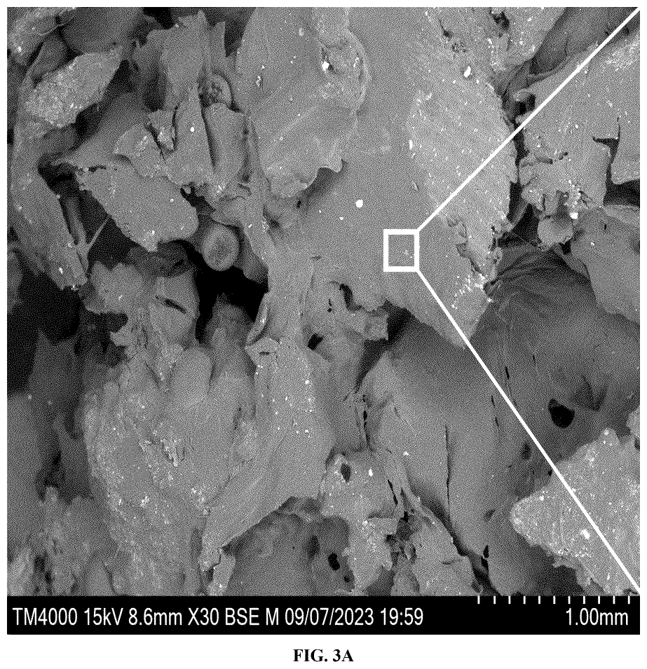

### DETAILED DESCRIPTION OF THE EMBODIMENTS

To make the objects, technical solutions, and advantages of the present disclosure clearer, the technical solutions in the examples of the present disclosure will be described clearly and completely below. Apparently, the described examples are merely some rather than all of the embodiments of the present disclosure. All other examples obtained by those skilled in the art based on the examples of the present disclosure without inventive labor should fall within the scope of the present disclosure.

The experimental methods described in the following examples are conventional methods unless otherwise specified; the raw materials and additives can be obtained from conventional commercial sources unless otherwise specified.

In the following examples and comparative examples, the test methods adopted are as follows:
1) The apparent characteristics of the biofilm were observed using a desktop electronic scanner (TM-4000, Japan).
2) The types of functional groups on the surface of the biofilm and native straw were compared using a Fourier transform infrared spectrometer.
3) A temperature of the pile was measured by inserting a portable thermometer from the side of a composting reaction tank, and the temperature was measured once every day separately at 8 o'clock in the morning and evening; an H₂S content was measured every day using a portable biogas detector (Biogas-5000, Geotech Company), and a daily H₂S emission was calculated according to formula (1):

$$E = \frac{101.375 \times 1000 \times Q \times 24 \times ( b - A ) \times {10}^{- 6} \times M}{8.314 \times ( 273 + {T}_{0} ) \times m} , \qquad formula ( 1 )$$

In formula (1), E (g/d·kg DM⁻¹) represents a daily emission of gas, Q (m³/h) represents a ventilation rate, b (ppm) represents a volume fraction of the gas, M (g/mol) represents a molar mass of the gas, T₀ (° C.) represents ambient temperature, and m represents a mass of dry matter.

The NH₃ was absorbed with boric acid with a mass fraction of 2%, and then titrated with 0.1 mol/L sulfuric acid for quantification, and a daily emission amount of the NH₃ was calculated according to formula (2):

$$E = \frac{V \times 3600 \times 24 \times 17.03}{1000 \times 2 C \times X \times m} , \qquad formula ( 2 )$$

in which, E (g/d·kg DM⁻¹) represents a daily emission of NH₃, V (mL) represents a dosage of sulfuric acid, C (mol/L) represents a concentration of sulfuric acid, X (s) represents a time to absorb NH₃, and m represents a mass of dry matter.

A cumulative emission of gas was calculated according to formula (3):

$${CE}_{n} = {\sum }_{i = 0}^{n} {E}_{i} , \qquad formula ( 3 )$$

in which, CEₙ (g/kg DM) represents a cumulative gas emission on the n-th day, and Ei represents a daily gas emission on the i-th day.

### Example 1

A method for preparing a straw-based modified biofilm was performed by the following procedure:
(1) Liquefaction of crop straw: polyethylene glycol-400 (PEG 400) and ethylene glycol (EG) were used as a liquefier, 98% concentrated sulfuric acid was used as a catalyst, the catalyst was added into the liquefier to obtain a mixed solvent, wherein the catalyst was added in an amount of 3% of a mass of the liquefier, and a mass ratio of the polyethylene glycol-400 (PEG 400) to the ethylene glycol (EG) in the liquefier was 3:1. The mixed solvent was added into a double-layer glass reactor with a volume of 5 L, stirred and heated to 150° C. Corn straw with a mass 1/7 that of the liquefier, a size of 2 meshes to 8 meshes, and a moisture content of 8% was added, and heated for another 30 min. The heating was terminated after the straw was fully liquefied, and a resulting liquefied product was removed from the reactor after cooling, consisting essentially of biological polyol.
(2) The biological polyol obtained in step (1), native corn straw with a size of 2 meshes to 8 meshes, and a polymer resin PAPI were mixed well in a mass ratio of 4:1:4, a resulting mixture was extended into a film, and the film was subjected to curing and molding by polymerizing at 75° C. for 15 min to obtain the straw-based modified biofilm.

The raw materials for preparing the biofilm (biological polyol, PAPI, and straw) has a total consumption of 1,950 g/m³.

The straw-based modified biofilm is black, and has a thickness of 1.1 cm, a tensile strength of 69.4 N, a bulk density of 19.7 kg·m⁻³, and a saturated water absorption rate of 1.03 g·g⁻¹.

The straw-based modified biofilm in step (2) was applied in in-situ control of odor emission during aerobic composting, which was performed by the following specific steps:

The composting was conducted in a 60 L closed fermentation tank, and the composting materials consisted of 85% fresh pig manure and 15% corn straw (based on wet weight). The pig manure and the corn straw were mixed and placed in the closed fermentation tank. The composting material was adjusted to have a moisture content adjusted of 65% and a carbon-to-nitrogen ratio of 15 to 25, and a ventilation rate was 0.24 L·kg⁻¹ DM·min⁻¹. The straw-based modified biofilm was covered on an upper surface of the composting material, and a pile was turned over every 7 days for a total of 42 days of composting. During the composting, the emissions of odor (NH₃, H₂S) were collected and measured daily.

The performance test results of the straw-based modified biofilm prepared in Example 1 were as follows:

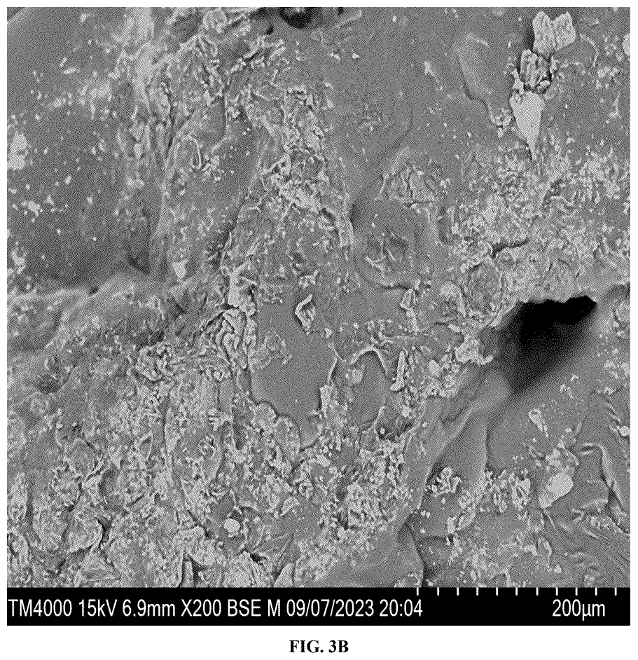

FIG. 3A-3B show that the surface of the biofilm prepared in this example has a complex pore structure, and the native straw is partially wrapped by the polyurethane foam produced during the curing, and is partially exposed on the surface of the biofilm. This indicates that the biofilm not only has the characteristics of polyurethane foam but also retains the properties of native straw to a certain extent.

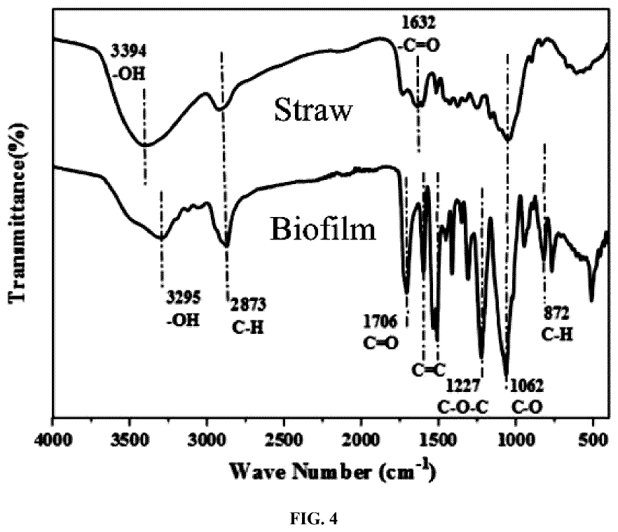

FIG. 4 shows that the functional groups on the surface of the biofilm prepared in this example is significantly different from those of native straw. Compared with native straw, the —OH stretching vibration peak on the biofilm surface is lower, the peak intensities of C—H, C═C, C═O, C—O—C, and C—O are larger, and there are additional stretching vibration peaks of aromatic C—H. This indicates that the biofilm surface contains more oxygen element and active groups.

### Comparative Example 1

This comparative example differs from Example 1 in that the surface of the composting material was not covered, and the remaining steps were consistent with those in Example 1.

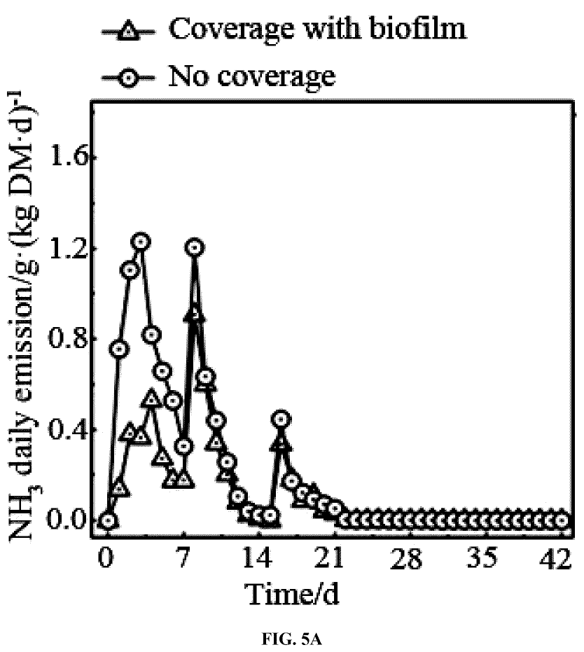

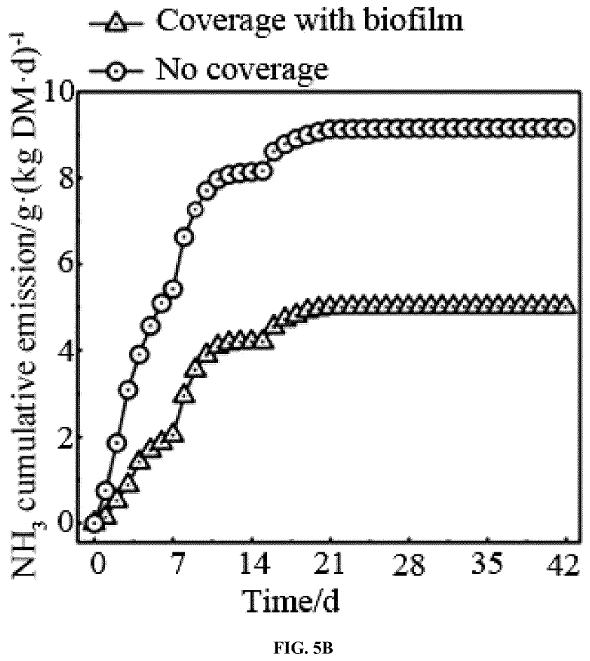

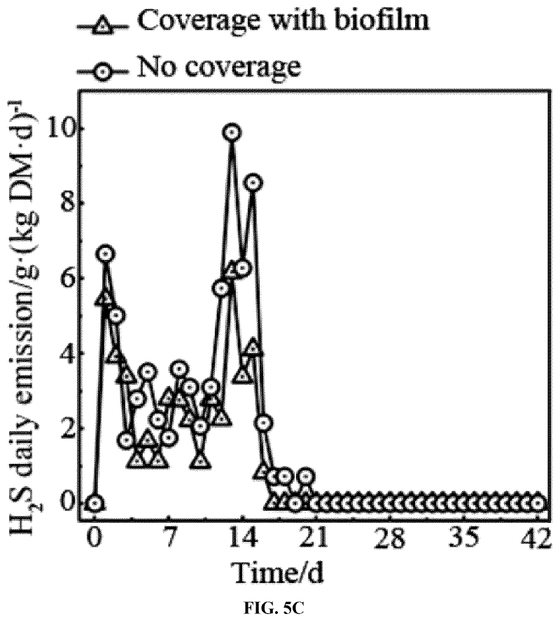

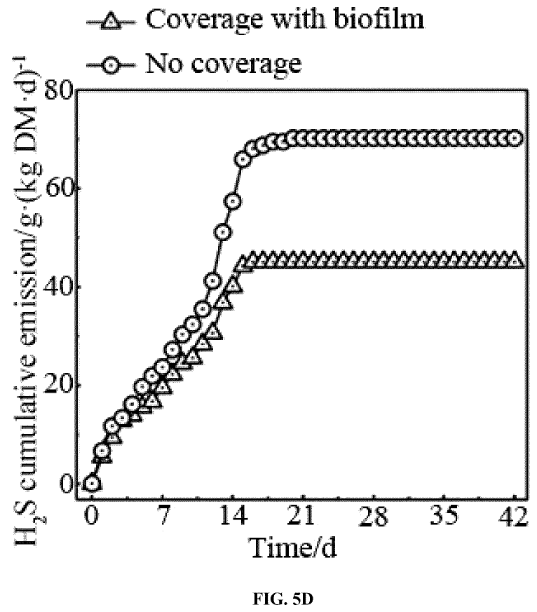

Performance tests were conducted on the emissions of NH₃ and H₂S during the composting of Example 1 and Comparative Example 1. FIG. 5A-5D show the emissions of NH₃ and H₂S during the composting. It might be due to the complex pore structure of the biofilm and the physical and chemical adsorption of odor by the oxygen-containing functional groups on the surface, compared with the case of Comparative Example 1 without covering, in the 42-days composting experiment, the biofilm of Example 1 reduces NH₃ and H₂S emissions by 45.27% and 35.85%, respectively.

### Comparative Example 2

This comparative example differs from Example 1 in that the straw-based modified biofilm was replaced with a molecular membrane (Oxford cloth+expanded polytetrafluoroethylene+Oxford cloth), and the remaining steps were consistent with those in Example 1. The results show that the molecular membrane has an emission reduction effect on composting odor that is close to that of Example 1, but its odor emission reduction cost is much higher than that of Example 1.

### Comparative Example 3

This comparative example differs from Example 1 in that the straw-based modified biofilm was replaced with corn straw, and the remaining steps were consistent with those in Example 1. The results show that corn straw is difficult to achieve a stable control effect on the odor emissions of aerobic composting, while the biofilm prepared in Example 1 could not only achieve entire in-situ control of the composting odor, but also has a more stable emission reduction effect.

### Comparative Example 4

This comparative example differs from Example 1 in that the straw-based modified biofilm was replaced with biochar. The results show that the biochar has a poor emission reduction effect on composting odor.

### Comparative Example 5

This comparative example differs from Example 1 in that the straw-based modified biofilm was replaced with a microbial inoculant (mainly Lactobacillus, Flavobacterium, Candida, Bacillus, Actinomycetes, Lysobacter, and Psychrobacter). The results show that the microbial inoculant could better control the emissions of composting odor. However, the use of expensive microbial inoculant could also significantly increase the cost of composting.

In the present disclosure, the influences of different sizes and different addition amounts of native corn straw (relative to the mass of biological polyol) on the mechanical strength of biofilm were also studied. Three sizes and four addition amounts of corn straw were selected, and a total of 12 biofilms with different structures were produced, and their tensile strengths were measured. The results are detailed in the table below:

| | Size (mesh) | | |
|---|---|---|---|
| Addition amount (%) | 2-8 | 8-16 | 16-40 |
| 25 | 69.4 | 55.5 | 54.0 |
| 50 | 28.3 | 38.8 | 45.6 |
| 100 | 27.0 | 34.0 | 38.8 |
| 150 | 9.4 | 8.6 | 7.8 |

The results prove that the tensile strength of the biofilm shows a decreasing trend with the increase in the addition amount of corn straw; and an excessively high addition amount of straw could cause the mechanical strength of the biofilm to decrease, such that the biofilm is easily break and inconvenient for transportation or use. When the straw was added in an amount of 25%, the cross-linking property of the polyurethane foam and straw reached saturation. At this time, the reduction in straw size could weaken the supporting performance of the biofilm, thus leading to a reduction in the tensile strength of the biofilm.

The above descriptions are merely preferred embodiments of the present disclosure. It should be noted that those skilled in the art may further make several improvements and modifications without departing from the principle of the present disclosure, but such improvements and modifications should be deemed as falling within the scope of the present disclosure.

What is claimed is:

1. A method for preparing a straw-based modified biofilm, comprising the following steps:
(1) mixing straw, a polyol, and a curing agent to obtain a mixture; and
(2) extending the mixture obtained in step (1) into a film, and subjecting the film to curing molding by reacting at a temperature of 70° C. to 80° C. for 15 min to 20 min to obtain the straw-based modified biofilm.

2. The method for preparing the straw-based modified biofilm according to claim 1, wherein a mass ratio of the straw, the polyol, and the curing agent in step (1) is in a range of (1-2):5:5.

3. The method for preparing the straw-based modified biofilm according to claim 1, wherein the polyol in step (1) is a biological polyol.

4. The method for preparing the straw-based modified biofilm according to claim 3, wherein the biological polyol is prepared by a process comprising the following steps:
mixing the straw, a liquefier, and a catalyst, and subjecting a resulting mixture to a reaction to obtain the biological polyol.

5. The method for preparing the straw-based modified biofilm according to claim 4, wherein the liquefier is a mixture of polyethylene glycol-400 and ethylene glycol, and a mass ratio of the polyethylene glycol-400 to the ethylene glycol in the mixture is in a range of 3:1 to 7:2;
the catalyst is concentrated sulfuric acid with a mass concentration of 98%, and the concentrated sulfuric acid is added in an amount of 2.8% to 3.2% of a mass of the liquefier;
the straw has a size of 2 meshes to 8 meshes and a moisture content of 5% to 10%; and
a mass ratio of the straw to the liquefier is in a range of 1:(7-8).

6. The method for preparing the straw-based modified biofilm according to claim 4, wherein the reaction is conducted at a temperature of 145° C. to 155° C. for 30 min to 40 min.

7. The method for preparing the straw-based modified biofilm according to claim 1, wherein the curing agent in step (1) comprises any one selected from the group consisting of polymethylene polyphenyl polyisocyanate (PAPI), toluene diisocyanate (TDI), and methylenediphenyl diisocyanate (MDI).

8. A straw-based modified biofilm prepared by the method according to claim 1.

9. A method for using the straw-based modified biofilm according to claim 8 in in-situ control of odor emission during aerobic composting, comprising the following steps:
covering the straw-based modified biofilm on a surface of a composting material.

10. The straw-based modified biofilm according to claim 8, wherein a mass ratio of the straw, the polyol, and the curing agent in step (1) is in a range of (1-2):5:5.

11. The straw-based modified biofilm according to claim 8, wherein the polyol in step (1) is a biological polyol.

12. The straw-based modified biofilm according to claim 11, wherein the biological polyol is prepared by a process comprising the following steps:
mixing the straw, a liquefier, and a catalyst, and subjecting a resulting mixture to a reaction to obtain the biological polyol.

13. The straw-based modified biofilm according to claim 12, wherein the liquefier is a mixture of polyethylene glycol-400 and ethylene glycol, and a mass ratio of the polyethylene glycol-400 to the ethylene glycol in the mixture is in a range of 3:1 to 7:2;
the catalyst is concentrated sulfuric acid with a mass concentration of 98%, and the concentrated sulfuric acid is added in an amount of 2.8% to 3.2% of a mass of the liquefier;
the straw has a size of 2 meshes to 8 meshes and a moisture content of 5% to 10%; and
a mass ratio of the straw to the liquefier is in a range of 1:(7-8).

14. The straw-based modified biofilm according to claim 12, wherein the reaction is conducted at a temperature of 145° C. to 155° C. for 30 min to 40 min.

15. The straw-based modified biofilm according to claim 8, wherein the curing agent in step (1) comprises any one selected from the group consisting of polymethylene polyphenyl polyisocyanate (PAPI), toluene diisocyanate (TDI), and methylenediphenyl diisocyanate (MDI).
